(19) United States
(12) Patent Application Publication
(10) Pub. No.: US 2013/0254858 A1
(43) Pub. Date: Sep. 26, 2013

(54) Encoding an Authentication Session in a QR Code

(71) Applicants: Nathan J. Giardina, San Diego, CA (US); David Tyree, Denver, CO (US)

(72) Inventors: Nathan J. Giardina, San Diego, CA (US); David Tyree, Denver, CO (US)

(73) Assignee: Computer Associates Think, Inc.

(21) Appl. No.: 13/429,631

(22) Filed: Mar. 26, 2012

(51) Int. Cl. G06F 21/00

(52) U.S. Cl. 726/7

(57) ABSTRACT

A system and method is provided for authenticating logins. An authentication server may receive a request for an authentication code from a requesting site, wherein the request is associated with a login session being performed via the requesting site and a first device associated with a user. The authentication server may generate the authentication code, wherein the authentication code comprises a universally unique identifier and an identifier that identifies the authentication server. The authentication server may communicate the generated authentication code to the requesting site. The authentication server may receive the universally unique identifier from a second device associated with the user, wherein the universally unique identifier is retrieved by decoding an optically captured representation of the authentication code at the second device. The authentication server may determine whether the login session is authenticated based on the universally unique identifier.

### TECHNICAL FIELD

The invention relates to the field of authentication systems. More particularly, the invention relates to utilizing optically recognizable codes for authentication purposes.

### BACKGROUND

Multi-factor authentication is generally considered to include three tiers of information: something you know, something you have, and something you are. With the prominence of mobile devices, multi-factor authentication is now being performed via these mobile devices. To allow a mobile device to be able to authenticate a user, an authentication session may need to be identified between a computer or browser and the mobile device and then between the mobile device and an authentication server capable of performing the authentication.

There is a need for making such mobile-based authentication easier to manage while still preventing intruder attacks such as, for example, phishing, MTM (man-in-the-middle), replay, or other types of attacks.

These and other drawbacks exist.

### SUMMARY

Various systems, computer program products, and methods for authenticating logins are described herein.

According to various implementations of the invention, the method may include a plurality of operations for authenticating logins. In some implementations, the operations may include receiving, by an authentication server, a request for an authentication code from a requesting site separate from the authentication server, wherein the request is associated with a login session being performed via the requesting site and a first device associated with a user. The operations may further include generating, by the authentication server, the authentication code, the authentication code comprising a universally unique identifier and an identifier that identifies the authentication server, the authentication code being encoded using an optical encoding that is configured to be decoded based on an optically captured representation of the authentication code. The operations may further include communicating, by the authentication server, the generated authentication code to the requesting site. The operations may further include receiving, by the authentication server, the universally unique identifier from a second device associated with the user, wherein the universally unique identifier is retrieved by decoding the authentication code at the second device, and wherein the second device is different than the first device. The operations may further include determining, by the authentication server, whether the login session is authenticated based on the universally unique identifier. The operations may further include generating, by the authentication server, authentication information based on the determination. The operations may further include communicating, by the authentication server, the authentication information to the requesting site, wherein the authentication information is displayed via the requesting site.

### BRIEF DESCRIPTION OF THE DRAWINGS

The accompanying drawings, which are incorporated into and constitute a part of this specification, illustrate one or more examples of implementations of the invention and, together with the description, serve to explain various principles and aspects of the invention.

FIG. 1 illustrates an exemplary system for authenticating logins, according to various aspects of the invention.

FIG. 2 is a data flow diagram illustrating process relationships in a system for authenticating logins, according to various aspects of the invention.

FIG. 3 illustrates an exemplary screenshot depicting a login interface, according to various aspects of the invention.

FIG. 4 illustrates an exemplary screenshot depicting an authentication code, according to various aspects of the invention.

FIG. 5 illustrates a flowchart depicting example operations performed by an authentication server, according to various aspects of the invention.

Reference will now be made in detail to various implementations of the invention as illustrated in the accompanying drawings. The same reference indicators will be used throughout the drawings and the following description to refer to the same or like items.

### DESCRIPTION OF EXEMPLARY IMPLEMENTATIONS

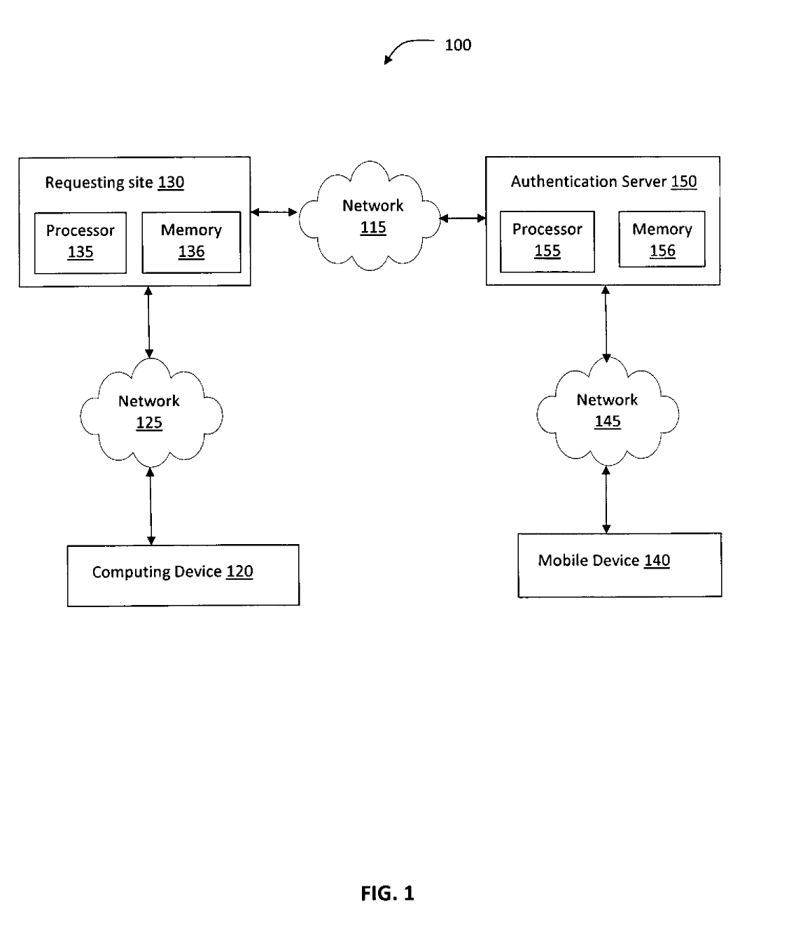

FIG. 1 is a block diagram illustrating an authentication system 100 that is configured to authenticate logins, according to an aspect of the invention. System 100 may include, among other things, an authentication server 150 that is configured to authenticate one or more login attempts associated with one or more users. Authentication server 150 may be communicatively coupled to a requesting site 130. In some implementations, the requesting site 130 may include a web server hosting a website, a computing device configured to execute a computer application, and/or any other computing device via which a session requiring one or more logins is performed.

In some implementations, the requesting site 130 may be communicatively coupled to computing device 120 (which may include a plurality of computing devices 120a . . . 120n not otherwise illustrated in FIG. 1) via network 125. In some implementations, authentication server 150 may be communicatively coupled to requesting site 130 via a network 115. In some implementations, authentication server 150 may be communicatively coupled to mobile device 140 via network 145. In some implementations, network 115, network 125, and network 145 may include a Local Area Network, a Wide Area Network, a cellular communications network, a Public Switched Telephone Network, and/or other network or combination of networks.

In some implementations, authentication server 150 may include a processor 155, a memory 156, and/or other components that facilitate the functions of authentication server 150. In some implementations, processor 155 includes one or more processors configured to perform various functions of authentication server 150. In some implementations, memory 156 includes one or more tangible (i.e., non-transitory) computer readable media. Memory 156 may include one or more instructions that when executed by processor 155 configure processor 155 to perform functions of authentication server 150. In some implementations, memory 156 may include one or more instructions stored on tangible computer readable media that when executed at a remote device, such as mobile device 140, cause the remote device to facilitate interaction with the authentication server, as described herein.

In some implementations, requesting site may include a processor 135, a memory 136, and/or other components that facilitate the functions of requesting site 130. In some implementations, processor 135 includes one or more processors configured to perform various functions of requesting site 130. In some implementations, memory 136 includes one or more tangible (i.e., non-transitory) computer readable media. Memory 136 may include one or more instructions that when executed by processor 135 configure processor 135 to perform functions of requesting site 130. In some implementations, memory 136 may include one or more instructions stored on tangible computer readable media that when executed at a remote device, such as computing device 120, cause the remote device to facilitate interaction with the requesting site, as described herein.

In some implementations, computing device 120 may include a computing/processing device such as a desktop computer, a laptop computer, a network computer, workstation, and/or other computing devices that may be utilized to interact with requesting site 130. In some implementations, computing device 120 may comprise a user interface (not otherwise illustrated in FIG. 1) that allows users to perform various operations that facilitate interaction with authentication server 150/system 100 including, for example, performing login sessions including making login attempts to access the requesting site, providing information associated with the login session and/or requested by the requesting site, and/or performing other operations. Computing device 120 may include a processor (not otherwise illustrated in FIG. 1), circuitry, and/or other hardware operable to execute computer-readable instructions.

In some implementations, mobile device 140 may include a computing/processing device such as a wireless phone, a personal digital assistant, a smart phone, a tablet computing device, and/or other portable computing device that may be utilized to interact with authentication server 150. In some implementations, mobile device 140 may include a camera (not illustrated in FIG. 1) that may be used to capture information displayed via computing device 120. Mobile device 140 may include a processor (not otherwise illustrated in FIG. 1), circuitry, and/or other hardware operable to execute computer-readable instructions.

In some implementations, mobile device 140 may execute a mobile authentication application (not otherwise illustrated in FIG. 1). The mobile authentication application may be utilized by a user to register with the authentication server 150. In some implementations, the user may register/associate users' credentials with the authentication server 150. During registration, the mobile authentication application may prompt the user to enter his/her user id (for example, user name, or other identifier) and password into a user interface associated with the mobile authentication application. The mobile authentication application may communicate with the authentication server 150 and transmit the user id and password to the authentication server 150. The authentication server 150 may generate a registration UUID (universally unique identifier) and store the registration UUID, user id, and password in a credential set at the authentication server 150 (in memory 156, for example). The authentication server 150 may communicate, to the mobile authentication application, the registration UUID which references the credential set stored at the authentication server 150. The mobile authentication application may store the registration UUID and user id at the mobile device 140. The password may be stored only at the authentication server 150 and not at the mobile device 140.

In some implementations, one or more user identities may be registered with the authentication server 150 via the mobile authentication application. For example, a user may have a first identity as an employee of an organization (in other words, a first role associated with the user) and a second identity as a manager of a particular group within the organization (in other words, a second role associated with the user). Information regarding one or more identities/roles associated with the user may be stored along with the registration UUID and user id at the mobile device 140. This information may also be stored in the credential set at the authentication server 150.

In some implementations, mobile device 140 may include a memory (not otherwise illustrated in FIG. 1) that includes one or more tangible (i.e., non-transitory) computer readable media. The memory may include one or more instructions that when executed by one or more processors configures the one or more processors to perform functions of mobile device 140/mobile authentication application. In some implementations, the registration UUID, user id and/or role information may be stored in the memory associated with the mobile device 140.

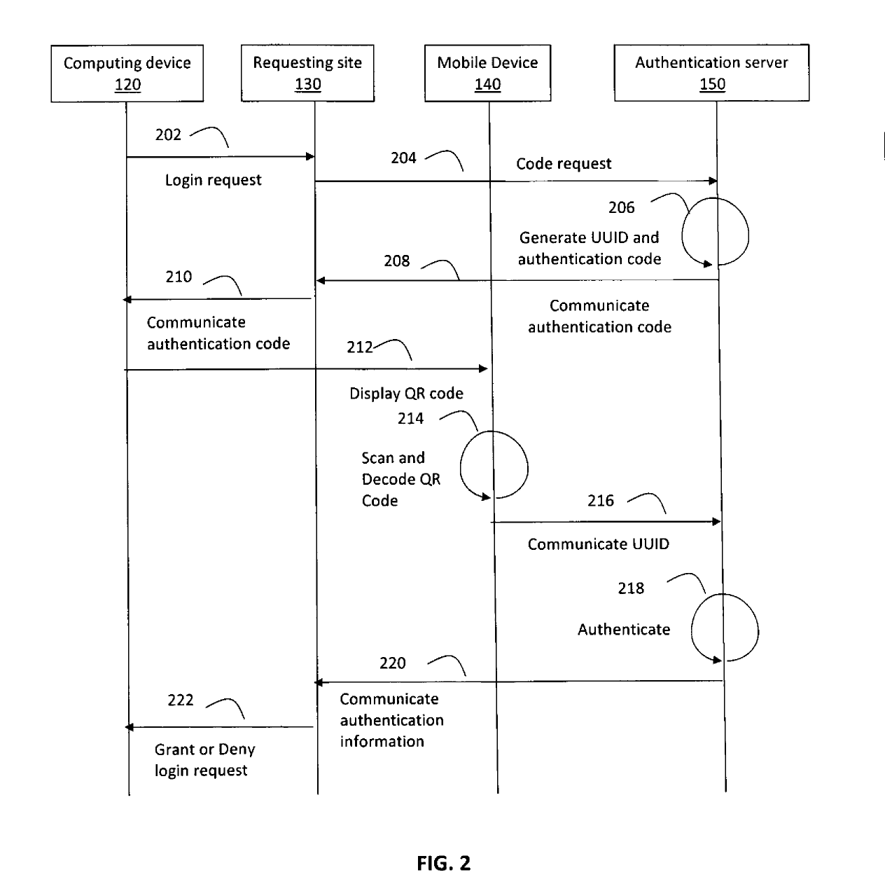

FIG. 2 depicts an exemplary data flow diagram illustrating process relationships in a system for authenticating logins. According to various aspects of the invention, a user may attempt to connect to a requesting site 130 via computing device 120 to gain access to one or more resources associated with the requesting site 130. In some implementations, requesting site 130 may receive a login request from computing device 120 in operation 202. In some implementations, a login session may be performed between the requesting site 130 and computing device 120, wherein the login session may include the login request.

In some implementations, the requesting site 130 may include a web server that hosts a website. In some implementations, computing device 120 may comprise a client computer application (for example, a web browser) that is configured to retrieve and display the website. In some implementations, the user may attempt to login to the website and the login request may be received by the web server.

In some implementations, in response to the login request, requesting site 130 may generate and communicate a request for an authentication code (hereinafter referred to as code request), in operation 204. In some implementations, authentication server 150 may receive the code request. In some implementations, the code request is associated with a login session being performed via the requesting site 130.

In some implementations, the code request may include a request for a session associated with the login request. In response to the code request, authentication server 150 may create a session for the requesting site 130 and/or user attempting to login via the requesting site 130. In some implementations, authentication server 150 may generate a session identifier for the session. In some implementations, the session may include an HTTP session associated via an HTTP cookie.

In some implementations, in response to the code request, authentication server 150 may generate an authentication UUID (universally unique identifier), in operation 206. In some implementations, the authentication UUID may identify the login session/login request. In some implementations, the authentication UUID may be used as a nonce which is a unique global identifier that is only used once. In some implementations, the authentication UUID may include the generated session identifier. Thus, the authentication UUID may be uniquely associated with the login session/login request without the authentication UUID being exposed to the client computer application associated with computing device 120.

In some implementations, authentication server 150 may map the authentication UUID to the requesting site 130. In some implementations, the authentication server 150 may store the mapping. In some implementations, authentication server 150 may store the generated authentication UUID and an identifier identifying the requesting site 130 (for example, web address, IP address, and/or other identifier). In some implementations, authentication server 150 may store the authentication UUID and the requesting site identifier in memory 156.

In some implementations, authentication server 150 may (in response to the code request) generate an authentication code, in operation 206. In some implementations, the authentication code may include the generated authentication UUID, an identifier that identifies the authentication server 150 (for example, web address, IP address, authentication server hostname, and/or other identifier), requested authentication parameters, and/or other information. In some implementations, the authentication code may be encoded using an optical encoding that is configured to be decoded based on an optically captured representation of the authentication code. For example, the optical encoding may include a QR code, a bar code, and/or any other code that encodes information and is recognizable by devices such as a camera or other image capture/scanning device. In some implementations, for example, a camera of mobile device 140 may be used to take a picture of the optical encoding for decoding at mobile device 140.

In some implementations, the requested authentication parameters may include one or more authentication methods for verifying the identity of the user requesting access to the requesting site 130 (i.e., performing the login session). For example, an authentication method may include capturing the location of the user requesting access, a video/audio of the user requesting access, a video/audio of the user requesting access while the user recites a particular word or phrase, and/or other authentication method.

In some implementations, authentication server 150 may encode the generated authentication UUID, the authentication server identifier, and/or authentication parameters into an authentication code. In some implementations, authentication sever 150 may communicate the generated authentication code to requesting site 130, in operation 208.

In some implementations, requesting site 130 may communicate the received authentication code to computing device 120, in operation 210. Computing device 120 may display the authentication code via the client computer application in operation 212.

In some implementations, mobile device 140 may capture the authentication code displayed via computing device 120 and decode the captured authentication code, in operation 214. In some implementations, mobile device 140 may include a camera which may be used to scan (i.e., optically capture) the authentication code. In some implementations, mobile device 140 may decode the authentication code to retrieve the authentication UUID, the authentication server identifier, authentication parameters, and/or other information encoded in the authentication code by the authentication server in operation 206.

In some implementations, mobile device 140 may communicate the authentication UUID retrieved from the authentication code to authentication server 150, in operation 216. In some implementations, mobile device 140 may utilize the authentication server identifier retrieved from the authentication code to connect to the authentication server 150 and communicate the retrieved authentication UUID to the authentication server 150. In this manner, mobile device 140 may identify authentication server 150 based on the decoded authentication code.

In some implementations, mobile device 140 may prompt the user of the mobile device 140 to provide additional information based on the authentication parameters retrieved from the authentication code. For example, the authentication parameter may indicate that a media record of the user be captured. In some implementations, the authentication parameter may indicate that a video and/or audio of the user be taken while reciting a phrase “I am happy”. In this case, the user may utilize the video recorder and/or microphone of mobile device 140 to record a video and/or audio of himself/herself while reciting the indicated phrase “I am happy”. In some implementations, the phrase “I am happy” may be used to ensure that the captured media is not subject to a replay attack and is changed with each login request. This ensures that an attacker cannot re-use a prior portion of captured media. In some implementations, mobile device 140 may communicate the requested additional information (for example, the recorded video) to the authentication server 150, in operation 216.

In some implementations, mobile device 140 may communicate the registration UUID that was previously generated during the registration process to authentication server 150, in operation 216.

In some implementations, authentication server 150 may receive the retrieved authentication UUID, the registration UUID, and/or requested additional information from the mobile device 140 and determine whether the login session is authenticated based on the retrieved authentication UUID, the registration UUID, and/or requested additional information in operation 218. In some implementations, authentication server 150 may determine, based on the retrieved authentication UUID, the registration UUID, and/or requested additional information, whether to grant or deny the login request.

In some implementations, authentication server 150 may receive the retrieved authentication UUID and perform certain authentication related functions based on the retrieved authentication UUID. In some implementations, authentication server 150 may determine whether the retrieved authentication UUID received from the mobile device 140 matches an active authentication UUID from a list of active authentication UUIDs stored at the authentication server 150. For example, the authentication server 150 may have generated a plurality of authentication UUIDs associated with a plurality of sessions (either associated with the user attempting to login or associated with other users of computing device 120) and each of these plurality of authentication UUIDs may be stored at the authentication server 150 (in a similar manner as described in operation 206, for example). Each authentication UUID has a particular expiration interval associated therewith. An authentication UUID may be considered active if the expiration interval has not expired. In some implementations, in response to a determination that the retrieved authentication UUID matches an active authentication UUID, a determination may be made that the login session associated with the active authentication UUID is authenticated. In response to a determination that the retrieved authentication UUID does not match an active authentication UUID, a determination may be made that the login session associated with the active authentication UUID is not authenticated.

In some implementations, authentication server 150 may receive the registration UUID and verify the identity of the user based on the registration UUID. In some implementations, authentication server 150 may determine whether the received registration UUID matches one of a plurality of registration UUIDs (associated with a plurality of users who have previously registered with the authentication server 150). In response to a match, a determination may be made the user is legitimate. In some implementations, authentication server 150 may identify the credential set associated with the user based on the registration UUID and may perform the determination based on the credential set.

In some implementations, authentication server 150 may receive the requested additional information and verify the identity of the user based on the information. For example, authentication server 150 may receive the captured media record (such as, recorded video) and perform facial recognition to determine whether certain facial features from the video match with the facial information (associated with the user) previously stored at the authentication server 150 (for example, during registration). In response to a match, authentication server 150 may determine that the user is legitimate, the login session is authentic, and may grant the login request. Other forms of captured media may be appropriately analyzed for authentication purposes.

In some implementations, the recorded video may be verified manually via an administrator or other user of the authentication server 150. In some implementations, authentication server 150 may include a user interface (such as, a console) which may allow an administrator to view and compare the recording with a previously stored media record.

In some implementations, based on a determination that the login session is authentic and/or the user is legitimate, authentication server 150 may determine that the login request may be granted. In some implementations, based on a determination that the login session is not authentic and/or the user is not legitimate, authentication server may determine that the login request may be denied. In some implementations, authentication server 150 may generate authentication information based on the determinations, in operation 220. In some implementations, the authentication information may include information regarding whether the login request is granted or denied.

In some implementations, authentication server 150 may identify the requesting site 130 based on the authentication UUID (based on the stored mapping, for example). In some implementations, authentication server 150 may communicate the authentication information to identified requesting site 130. In some implementations, requesting site 130 may communicate an indication that the login request is granted or denied based on the authentication information. In some implementations, requesting site 130 may communicate the indication to computing device 120 that provided the login request, in operation 222.

In some implementations, in response to a determination that the login request is granted, authentication server 150 may communicate the identified credential set (identified based on the registration UUID) to the computing device 120 (i.e., the client computer application associated with the computing device 120). In some implementations, authentication server 150 may communicate the identified credential set (including user id and password) in response to an AJAX long polling request previously communicated to the authentication server 150 by client computer application indicating that the client computer application is waiting for credentials to be returned. In some implementations, the client computer application may populate a login form displayed via a website with the received credentials and complete authentication for the user.

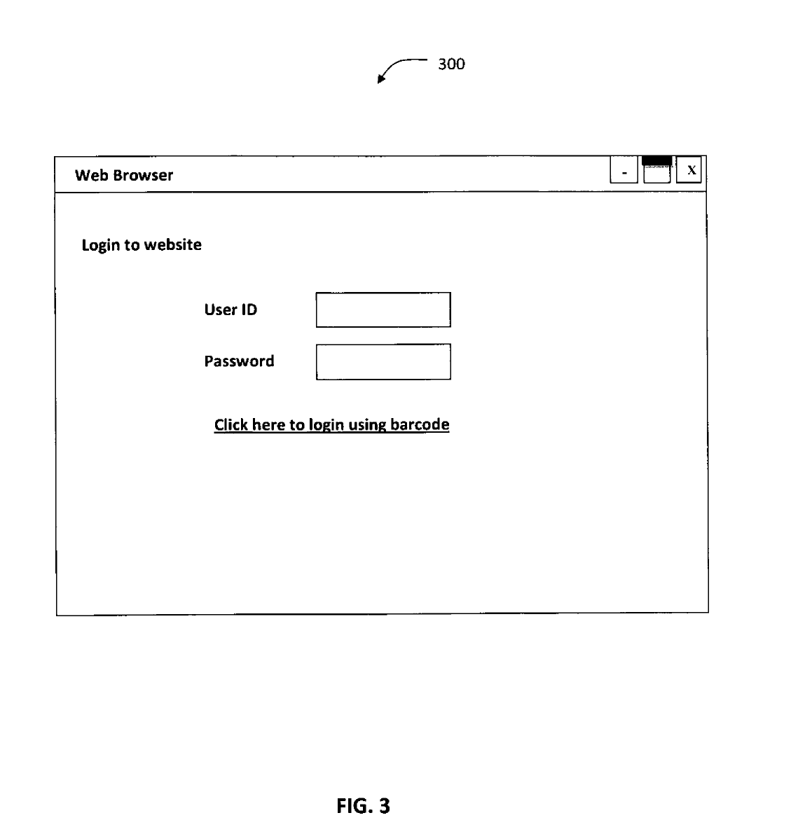

FIG. 3 illustrates an exemplary screenshot 300 depicting a login interface, according to various aspects of the invention. FIG. 3 and other screenshot figures are for illustrative purposes only and should not be viewed as limiting. Various interface elements may be included, excluded, or otherwise configured differently as would be appreciated. As illustrated, FIG. 3 depicts a website that can be displayed by, for example, computing device 120. A user may attempt to login to the website by selecting the option “click here to login using barcode” (instead of entering user's id or password, for example). Upon selection of the hyperlink providing the user of the option of logging in using a barcode, a requesting site 130 may provide a code request to authentication server 150. Authentication server 150 may generate an authentication code (for example, barcode) and communicate the generated authentication code to the requesting site 130. The authentication code may be displayed via the website. As such, the authentication code may be used for authentication purposes as described above and a user is relieved of remembering user ids and passwords thereby making it easier to login. As would be appreciated based on the disclosure herein, other configurations may be used. For example, both the barcode and the text input authentication (in the form of a login form) mechanisms may be simultaneously presented.

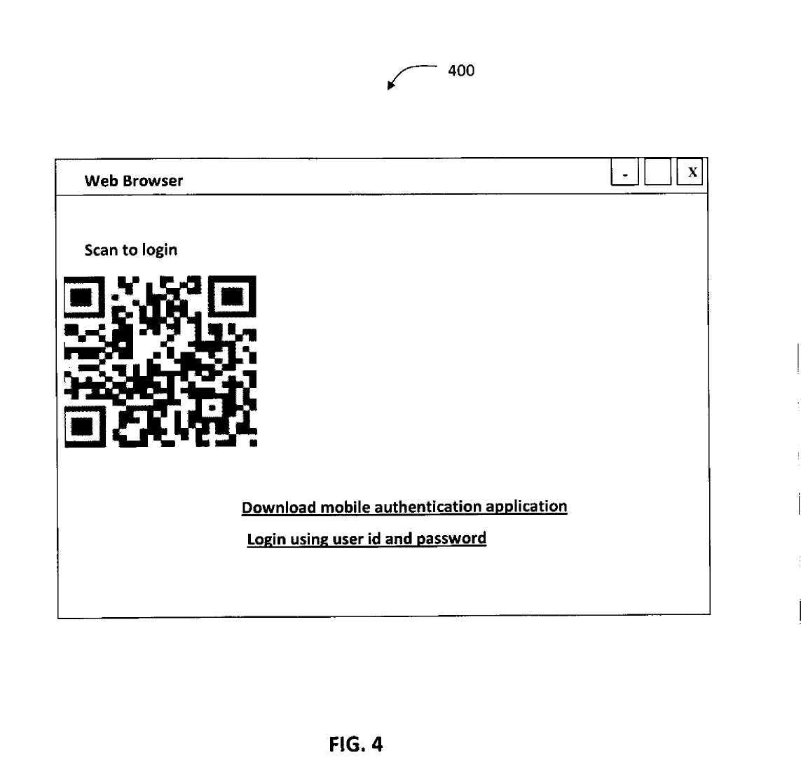

FIG. 4 depicts an exemplary screenshot 400 depicting the authentication code provided by the authentication server 150. The authentication code displayed on computing device 120 may be scanned by mobile device 140. In some implementations, a user may be provided with an option to download a mobile authentication application onto mobile device 140. In some implementations, the mobile authentication application once downloaded (or opened if already previously downloaded) may prompt the user to scan the authentication code. Once scanned, the mobile authentication application may decode the authentication code. The mobile authentication application may retrieve the authentication UUID, the authentication server identifier, and/or the authentication parameters. In some implementations, mobile authentication application may display a number of identities or roles associated with the user and may prompt the user to choose an identity or role for authentication purposes. In some implementations, mobile authentication application may prompt the user to provide additional information based on the authentication parameters. In some implementations, the mobile authentication application may communicate the authentication UUID, registration UUID, identity/role information used to authenticate, and/or the additional information to authentication server 150.

In some implementations, authentication server 150 may verify the identity of the user based on the registration UUID and/or identity/role information. In some implementations, authentication server 150 may identify a credential set associated with the user based on the registration UUID and/or identity/role information.

In some implementations, a user may be provided with an option to login using a user id and password (in case the authentication code could not be scanned, for example). In response to the user selecting to login using user id and password, the user may be provided with the screen of FIG. 3 where the user may enter a user id and password.

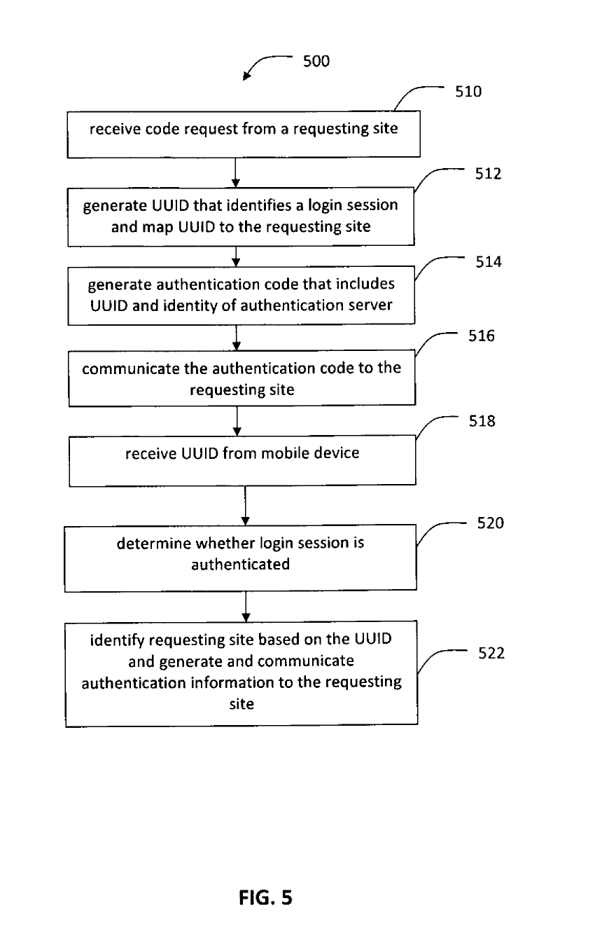

FIG. 5 is a flowchart 500 depicting example operations performed by the authentication server, according to various aspects of the invention. In some implementations, the described operations may be accomplished using one or more of the modules/components described herein. In some implementations, various operations may be performed in different sequences. In other implementations, additional operations may be performed along with some or all of the operations shown in FIG. 5. In yet other implementations, one or more operations may be performed simultaneously. In yet other implementations, one or more operations may not be performed. Accordingly, the operations described are exemplary in nature and, as such, should not be viewed as limiting.

In an operation 510, process 500 may receive a code request from requesting site 130. In response to code request, process 500 may generate an authentication UUID that identifies a login session being performed via requesting site 130 and computing device 120, in operation 512. In some implementations, process 500 may map the authentication UUID to the requesting site 130 that sent the code request.

In an operation 514, process 500 may generate an authentication code (in response to the code request) that includes the authentication UUID, an identity of the authentication server, one or more authentication parameters, and/or other information. In an operation 516, process 500 may communicate the authentication code to the requesting site 130.

In some implementations, requesting site 130 may communicate the received authentication code to computing device 120. Computing device 120 may display the authentication code via the client computer application, for example a web browser.

In some implementations, mobile device 140 may capture the authentication code displayed via computing device 120 and decode the captured authentication code to retrieve the authentication UUID, the authentication server identifier, and/or the authentication parameters. In some implementations, mobile device 140 may receive additional information from the user based on the authentication parameters.

In an operation 518, process 500 may receive, from the mobile device 140, the retrieved authentication UUID, registration UUID stored at mobile device 140, and/or additional information that was captured at the mobile device 140 based on the authentication parameters. In an operation 520, process 500 may determine whether the login session is authenticated based on the authentication UUID, registration UUID. and/or the additional captured information.

In an operation 522, process 500 may generate authentication information based on the determination performed in operation 520. In some implementations, the authentication information may include information regarding whether a login request associated with the login session is granted or denied.

In some implementations, in operation 522, process 500 may identify the requesting site 130 based on the authentication UUID and communicate the authentication information to the requesting site 130.

Implementations of the invention may be made in hardware, firmware, software, or various combinations thereof. The invention may also be implemented as computer-readable instructions stored on a tangible computer-readable storage medium which may be read and executed by one or more processors. A computer-readable storage medium may include various mechanisms for storing information in a form readable by a computing device. For example, a tangible computer-readable storage medium may include optical storage media, flash memory devices, and/or other storage mediums. Further, firmware, software, routines, or instructions may be described in the above disclosure in terms of specific exemplary aspects and implementations of the invention and performing certain actions. However, it will be apparent that such descriptions are merely for convenience, and that such actions may in fact result from computing devices, processors, controllers, or other devices executing firmware, software, routines or instructions.

Other embodiments, uses and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. A method for authenticating logins, the method comprising:
receiving, by an authentication server, a request for an authentication code from a requesting site separate from the authentication server, wherein the request is associated with a login session being performed via the requesting site and a first device associated with a user;
generating, by the authentication server, the authentication code, the authentication code comprising a universally unique identifier and an identifier that identifies the authentication server, the authentication code being encoded using an optical encoding that is configured to be decoded based on an optically captured representation of the authentication code;
communicating, by the authentication server, the generated authentication code to the requesting site;
receiving, by the authentication server, the universally unique identifier from a second device associated with the user, wherein the universally unique identifier is retrieved by decoding the authentication code at the second device, and wherein the second device is different than the first device;
determining, by the authentication server, whether the login session is authenticated based on the universally unique identifier;
generating, by the authentication server, authentication information based on the determination; and
communicating, by the authentication server, the authentication information to the requesting site, wherein the authentication information is displayed at the first device.

2. The method of claim 1, wherein the authentication code comprises one or more authentication parameters used to verify an identity of the user.

3. The method of claim 2, wherein the one or more authentication parameters comprises a media record of the user captured at the second device while the user recites a particular phrase.

4. The method of claim 3, further comprising:
receiving, by the authentication server, the media record from the second device;
verifying, automatically by the authentication server, the identity of the user based on the media record; and
determining, by the authentication server, whether the login session is authenticated based on the universally unique identifier and the verification.

5. The method of claim 3, further comprising:
receiving, by the authentication server, the media record from the second device;
manually verifying the identity of the user based on the media record; and
determining, by the authentication server, whether the login session is authenticated based on the universally unique identifier and the verification.

6. The method of claim 1, wherein the authentication information comprises information regarding whether a login request associated with the login session is granted or denied.

7. The method of claim 1, wherein the authentication code comprises a OR code or a barcode.

8. A system for authenticating logins, the system comprising one or more processors configured to:
receive a request for an authentication code from a requesting site separate from the authentication server, wherein the request is associated with a login session being performed via the requesting site and a first device associated with a user;
generate the authentication code, the authentication code comprising a universally unique identifier and an identifier that identifies the authentication server, the authentication code being encoded using an optical encoding that is configured to be decoded based on an optically captured representation of the authentication code;
communicate the generated authentication code to the requesting site;
receive the universally unique identifier from a second device associated with the user, wherein the universally unique identifier is retrieved by decoding the authentication code at the second device, and wherein the second device is different than the first device;
determine whether the login session is authenticated based on the universally unique identifier;
generate authentication information based on the determination; and
communicate the authentication information to the requesting site, wherein the authentication information is displayed at the first device.

9. The system of claim 8, wherein the authentication code comprises one or more authentication parameters used to verify an identity of the user.

10. The system of claim 9, wherein the one or more authentication parameters comprises a media record of the user captured at the second device while the user recites a particular phrase.

11. The system of claim 10, wherein the one or more processors are further configured to:
receive the media record from the second device;
automatically verify the identity of the user based on the media record; and
determine whether the login session is authenticated based on the universally unique identifier and the verification.

12. The system of claim 10, wherein the one or more processors are further configured to:
receive the media record from the second device; and
determine whether the login session is authenticated based on the universally unique identifier and a manual verification of the identity of the user based on the media record.

13. The system of claim 8, wherein the authentication information comprises information regarding whether a login request associated with the login session is granted or denied.

14. The system of claim 8, wherein the authentication code comprises a QR code or a barcode.

15. A tangible computer readable medium having one or more computer-readable instructions thereon which when executed by one or more processors cause the one or more processors to:
capture, by a first device associated with the user, an authentication code displayed on a second device associated with the user, wherein the second device is different than the first device, wherein the authentication code comprises a universally unique identifier and an identifier that identifies an authentication server; and wherein the second device displays the authentication code via a website hosted by a web server and the authentication code is generated by the authentication server;
decode, by the first device, from the captured authentication the universally unique identifier and identifier that identifies the authentication server; and
communicate, by the first device, the universally unique identifier to the authentication server based on the identifier, wherein a login session is verified based on the communicated universally unique identifier.

16. The tangible computer readable medium of claim 15, wherein the instructions cause the processors to optically capture the authentication code displayed on the second device.
